(19) United States
(12) Patent Application Publication
(10) Pub. No.: US 2014/0006083 A1
(43) Pub. Date: Jan. 2, 2014

(54) PROPERTY SHOWING APPOINTMENT SCHEDULING SYSTEM AND METHOD

(71) Applicant: Showing Suite, Inc., San Diego, CA (US)

(72) Inventors: Rick Robert Bengson, San Diego, CA (US); Seth Siegler, San Diego, CA (US)

(21) Appl. No.: 13/929,327

(22) Filed: Jun. 27, 2013

Related U.S. Application Data
(60) Provisional application No. 61/664,988, filed on Jun. 27, 2012.

(51) Int. Cl. G06Q 50/16; G06Q 10/10

(52) U.S. Cl. CPC G06Q 50/16; G06Q 10/1095
USPC 705/7.19

(57) ABSTRACT

A method for scheduling a property showing includes receiving an electronic communication from a buyer, wherein the electronic communication from the buyer includes identification data to uniquely identify a property, and requested showing time data including a requested showing time for the property. It is determined whether confirmation by a seller is required prior to showing the property. If the confirmation by the seller is not required, a showing at the requested time is scheduled. Showing instructions for the property are retrieved and electronically communicated to the buyer. If confirmation by the seller is required, a confirmation request is sent to the seller via an electronic communication.

### CROSS REFERENCE TO RELATED APPLICATIONS

This application claims the benefit of U.S. Pat. Appl. No. 61/664,988 filed on Jun. 27, 2012, the entirety of which is herein incorporated by reference.

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND

Generally, this application relates to techniques for real estate showings. Specifically, this application describes systems and methods for automatedly coordinating appointments between buyers and sellers for the showing of properties.

As used herein, the term “buyer” may encompass one or more parties, including the (potential) buyer, the buyer's agent (for example, a showing agent), and/or any other party authorized to act on behalf of the buyer. As used herein, the term “seller” may encompass one or more parties, including the (potential) seller, multiple sellers, one or more tenants, the seller's agent (for example, a listing agent), and/or any other party authorized to act on behalf of the seller.

### SUMMARY

According to certain inventive techniques, a method for scheduling a property showing with a data processing system includes receiving, by the data processing system, an electronic communication from a buyer. The electronic communication from the buyer includes identification data to uniquely identify a property and requested showing time data including a requested showing time for the property. The data processing system determines whether confirmation by a seller is required prior to showing the property. If the confirmation by the seller is not required, the data processing system schedules a showing at the property during the requested showing time. The data processing system determines whether showing instructions corresponding to the property are available. If the showing instructions are available, the data processing system retrieves the showing instructions and electronically communicates the showing instructions to the buyer. If confirmation by the seller is required, the data processing system sends confirmation request via an electronic communication to the seller requesting a showing of the property at the requested showing time.

If confirmation by the seller is required, the data processing system may receive an electronic communication from the seller including a confirmation result in response to the confirmation request, wherein the confirmation result includes a confirmation result to show the property at the requested showing time, a denial to show the property at the requested showing time, or a request to reschedule the property showing from the requested showing time to a different showing time. The data processing system may then send an electronic communication to the buyer including the confirmation result.

If the confirmation result includes a confirmation result to show the property at the requested showing time, the data processing system may: schedule the property showing at the requested showing time; determine whether the showing instructions are available; if the showing instructions are available, retrieve the showing instructions; and if the showing instructions have been retrieved, send an electronic communication to the buyer including the showing instructions. One electronic communication may include both: the electronic communication to the buyer including the confirmation result; and the electronic communication to the buyer including the showing instructions. If confirmation by the seller is required, the data processing system may determine a contact preference for the seller and may send the electronic communication to the seller according to the contact preference.

According to certain inventive techniques, a method for scheduling a plurality of property showings with a data processing system includes receiving, by the data processing system, at least one electronic communication from a buyer. The at least one electronic communication from the buyer includes identification data to uniquely identify each of a plurality of properties and requested showing time data including a requested showing time for each of the plurality of properties. For each of the plurality of properties, the data processing system determines whether confirmation by a corresponding seller is required. For each of the plurality of properties, if the confirmation by a given seller is not required, the data processing system: schedules a showing at a given one of the plurality of properties during a corresponding requested showing time; determines whether showing instructions for the given one of the plurality of properties are available; if the showing instructions are available, retrieves the showing instructions; and if the showing instructions have been retrieved, electronically communicates the showing instructions to the buyer. For each of the plurality of properties, if confirmation by a given seller is required, the data processing system sends a confirmation request via an electronic communication to the given seller requesting a showing of a given one of the plurality of properties at the requested showing time.

If confirmation by the given seller is required, the data processing system may receive an electronic communication from the given seller including a confirmation result in response to a corresponding confirmation request, wherein the confirmation result includes a confirmation result to show a given one of the plurality of properties at a corresponding requested showing time, a denial to show the given one of the plurality of properties at the requested showing time, or a request to reschedule the property showing from the corresponding requested showing time to a different showing time. The data processing system may send an electronic communication to the buyer including the confirmation result.

If the confirmation result comprises a confirmation result to show the given one of the plurality of properties at the corresponding requested showing time, the data processing system may schedule a property showing for the given one of the plurality of properties at the corresponding requested showing time. The data processing system may determine whether showing instructions are available for the given one of the plurality of properties. If the showing instructions for the given one of the plurality of properties are available, the data processing system may retrieve the showing instructions for the given one of the plurality of properties. If the showing instructions for the given one of the plurality of properties have been retrieved, the data processing system may send an electronic communication to the buyer including the showing instructions for the given one of the plurality of properties. One electronic communication may include both each electronic communication to the buyer including the confirmation result and each electronic communication to the buyer including the showing instructions.

For each of the plurality of properties, if confirmation by the given seller is required, the data processing system may determine a contact preference for the given seller. The data processing system may send the electronic communication to the given seller according to the contact preference.

The above-described methods may be implemented by a data processing system. The above-described methods may be implemented by instructions stored on at least one computer readable medium, where the instructions executable to cause a data processing system to perform the methods.

### BRIEF DESCRIPTION OF SEVERAL VIEWS OF THE DRAWINGS

FIGS. 1A and 1B illustrate representations of a system including a property appointment showing coordination system, according to certain inventive techniques.

FIG. 2 illustrates a flowchart of a method for coordinating property showing appointments, according to certain inventive techniques.

FIGS. 3-7 illustrate additional or optional details of the techniques described with respect to FIG. 2, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

Techniques of the disclosed herein offer an easy way for real estate agents to schedule and confirm showing appointments via email, telephone, text message (for example, short messaging service (“SMS”) or multimedia messaging service (“MMS”)), or push notifications.

Benefits flowing from the inventive techniques disclosed herein allow for a showing real estate agent to schedule showing appointments for any number of properties by calling or texting to a single phone number or sending a single email. The automated confirmation process handles the simultaneous contact of any number of parties responsible for confirmation of each showing via phone call, text message, email, or push notifications.

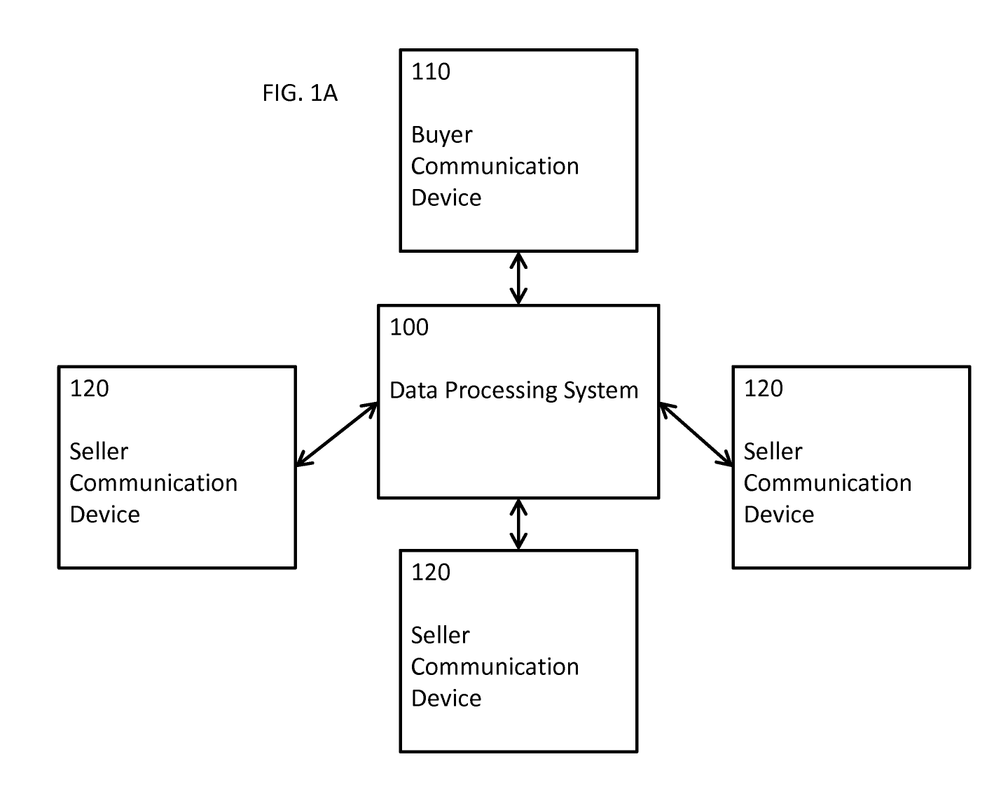

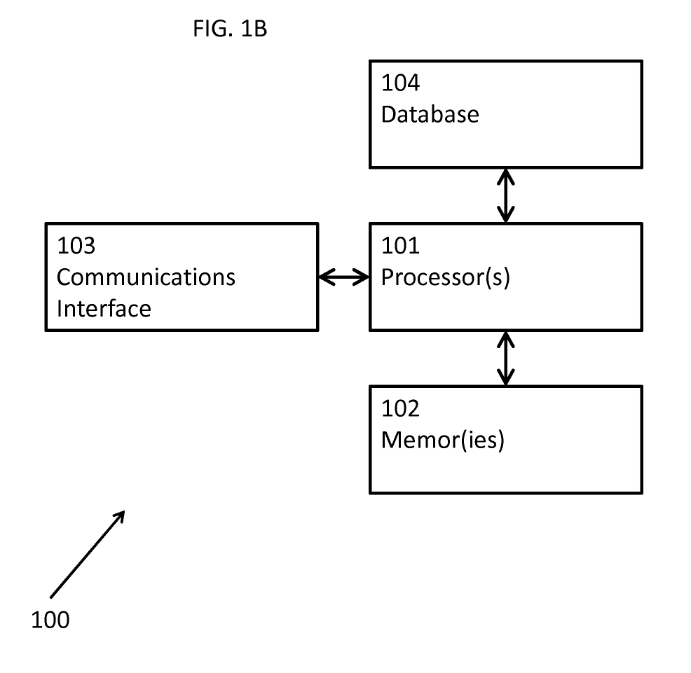

FIG. 1A illustrates a representation of a system including a property showing coordination system, according to certain inventive techniques. A data processing system 100 (which may be referred to as a “showing robot”) may be in communication (for example, through the Internet) with a buyer communication device 110. Such a device 110 may include a stationary computing device (for example, a desktop computer or the like) or mobile computing device (for example, a mobile phone, a laptop, a tablet, a personal digital assistant, or the like). The data processing system 100 may also be in communication (for example, through the Internet) with one or more seller communication devices 120. Such a device 120 may include a stationary computing device (for example, a desktop computer or the like) or mobile computing device (for example, a mobile phone, a laptop, a tablet, a personal digital assistant, or the like).

FIG. 1B illustrates a representation of the data processing system 100. The data processing system 100 may include one or more processors 101, one or more memories 102, a communications interface 103, and/or a database 104. The one or more memories 102 may include one or more computer-readable storage mediums that include a set of instructions executable by the processor(s) 101. The instructions may be executable by the processor(s) 101 to perform operations such as those disclosed in the methods and other techniques discussed herein.

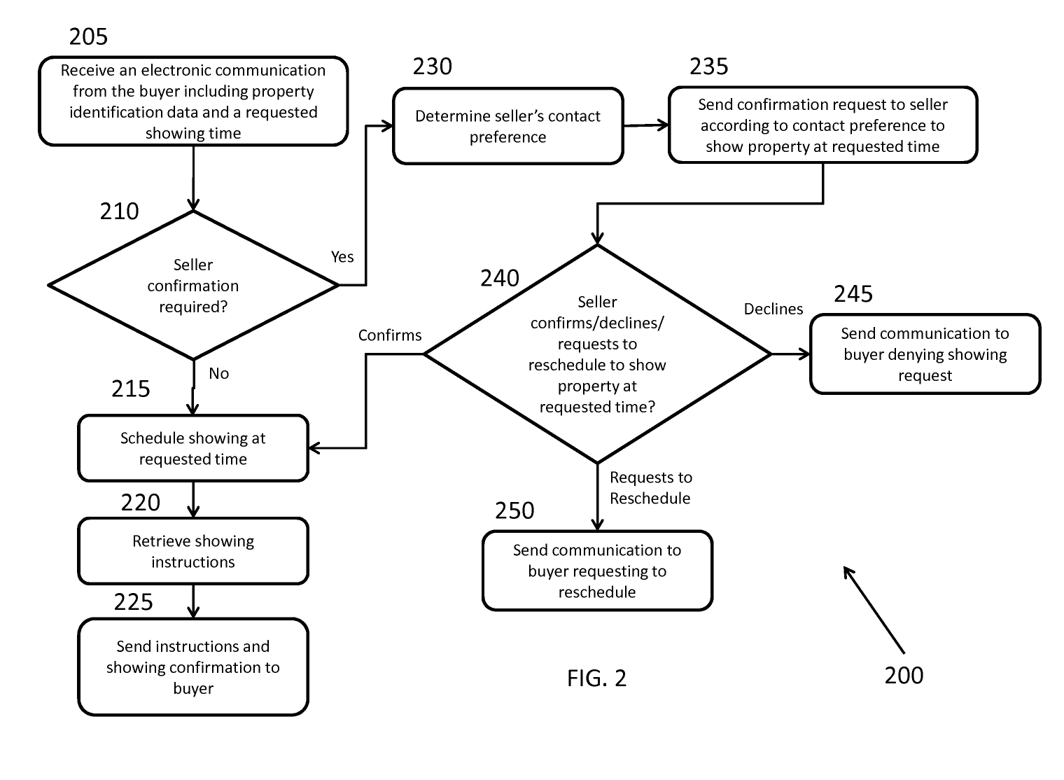

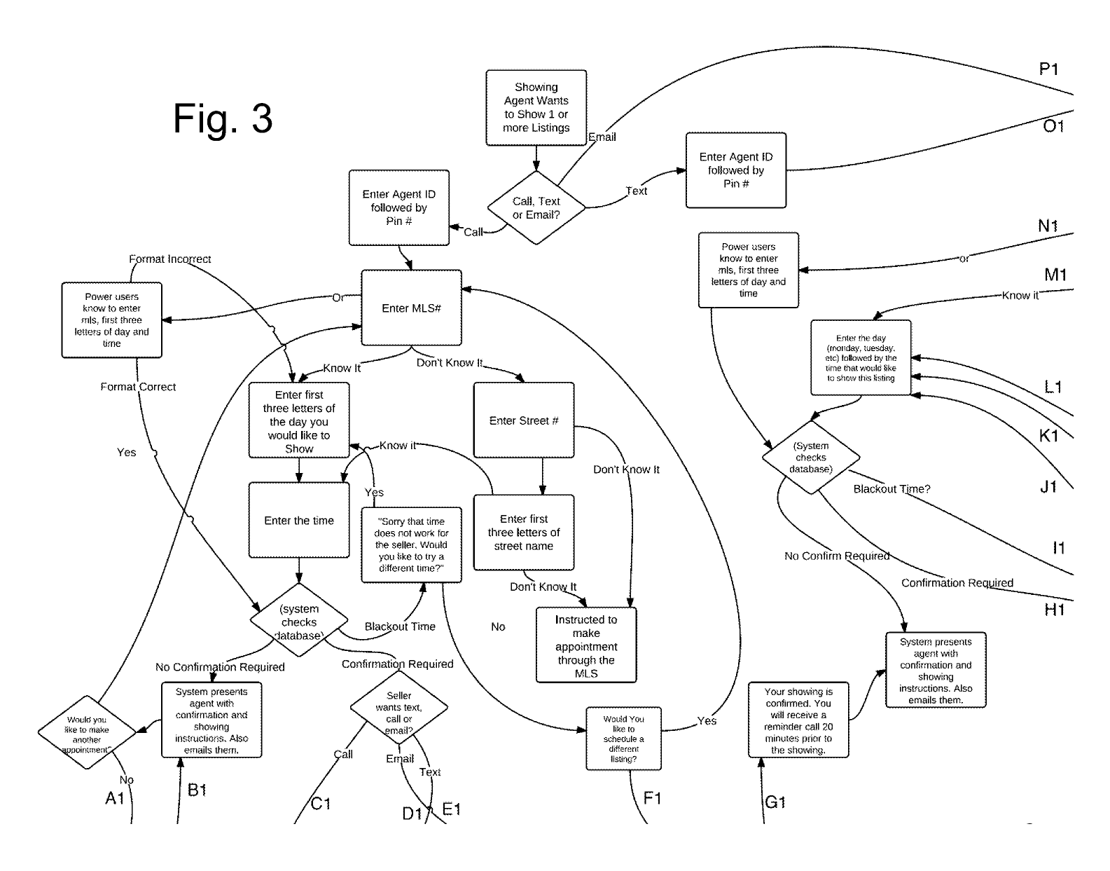

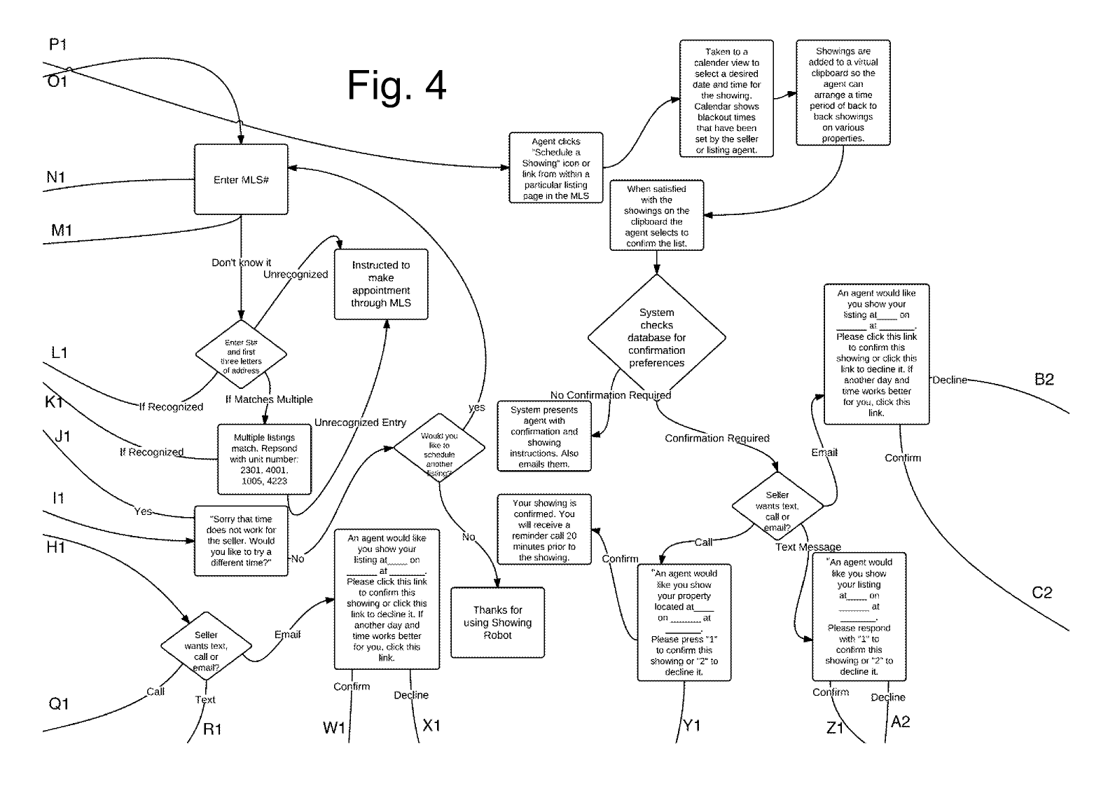

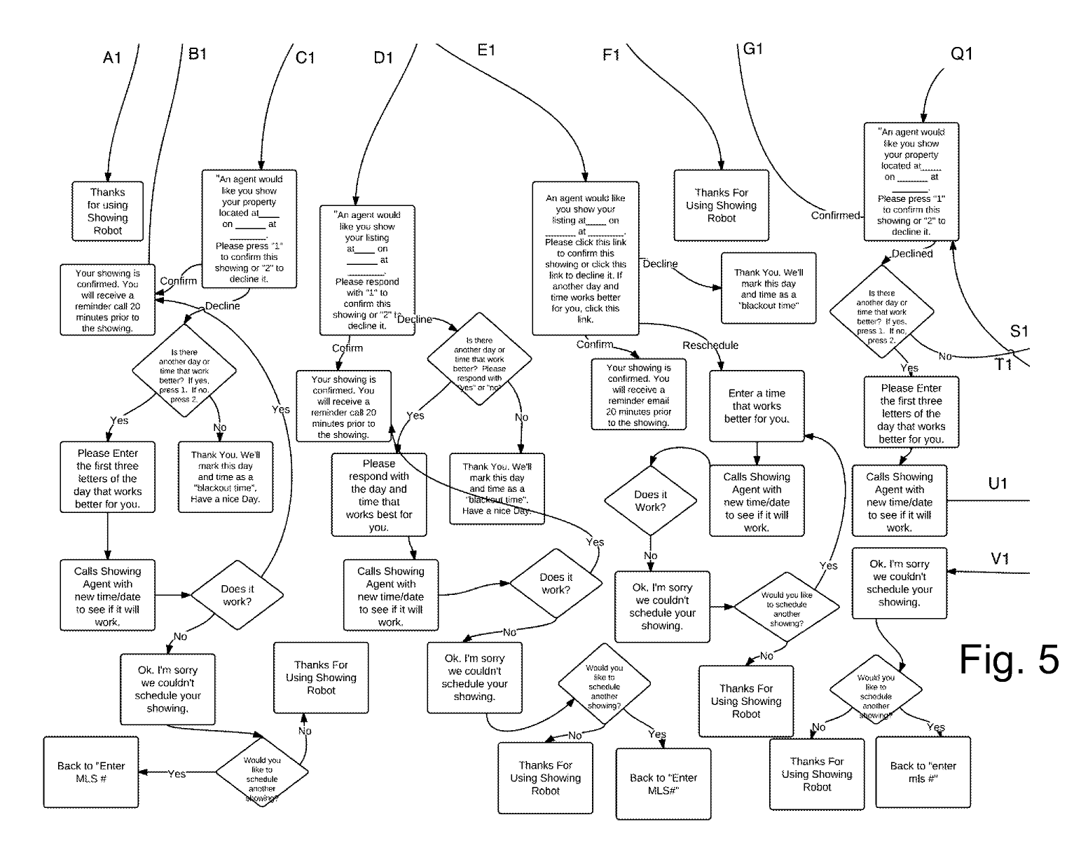

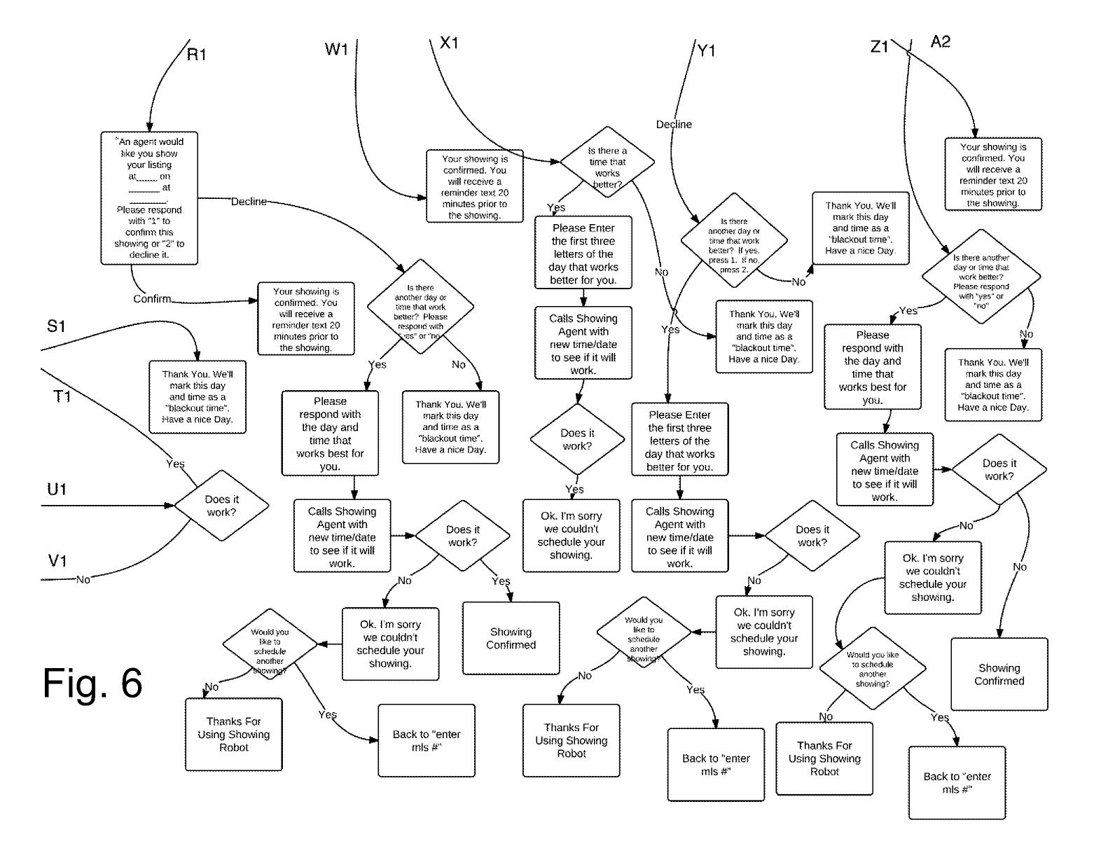

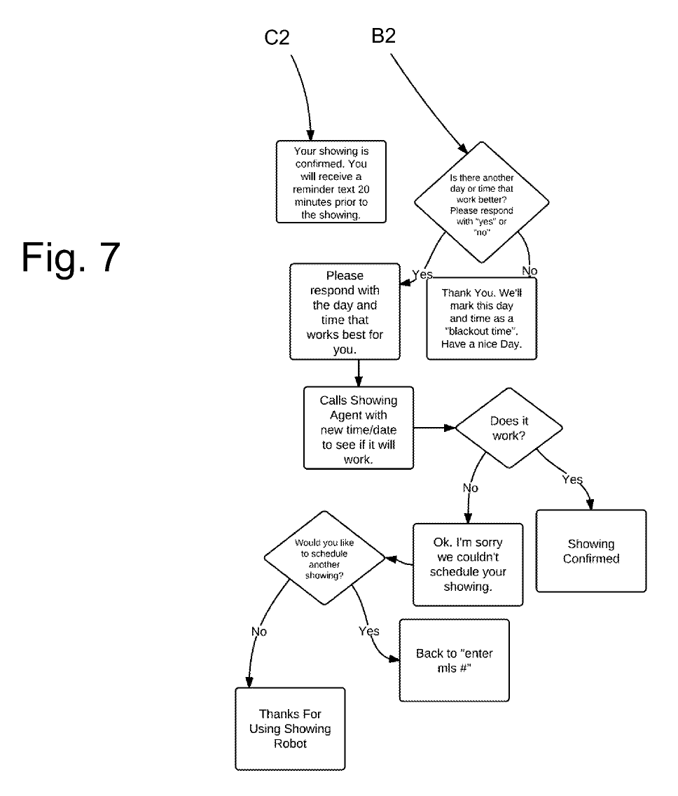

FIG. 2 illustrates a flowchart 200 for a method of coordinating property showing appointments, according to certain inventive techniques. The steps illustrated in the flowchart 200 may be performable at least in part by a data processing system, such as data processing system 100. The steps illustrated in the flowchart 200 may be performable at least in part by one or more processing units, such as the processing units. Furthermore, the steps illustrated in the flowchart 200 may be performable in a different order, or some steps may be omitted according to design and/or clinical preferences. The steps illustrated in the flowchart 200, or a portion thereof, may be performable by software, hardware, and/or firmware. The steps illustrated in the flowchart 200, or a portion thereof, may also be expressible through a set of instructions stored on one or more computer-readable storage media (for example, the one or more memories 102), such as RAM, ROM, EPROM, EEPROM, optical disk, magnetic disk, magnetic tape, and/or the like. Additional details of the method may be depicted in FIGS. 3-7.

At step 205, an electronic communication from the buyer is received. The electronic communication may include property identification data (for example, address or MLS listing number) and requested showing time(s) for one or more properties. The requested showing time may specify the day and the time of day. The electronic communication may be included in an automated phone call, an email, a text, or through an Internet portal such as a website. If the electronic communication is included in an automated phone call, the data processing system may prompt the buyer to answer a series of questions (for example, automated prompts) as part of the automated phone call. The buyer may enter responses through a keypad on the phone or by speaking into the phone.

According to one technique, a buyer may send a text message (for example, SMS or MMS) to a designated phone number associated with the data processing system. The data processing system may receive the phone call. If the electronic communication is a text, there may actually be a series of texts between the data processing system and the buyer. For example, the data processing system may prompt the buyer through texts to answer questions and may also provide feedback to the buyer through texts. Such a series of texts may be considered to be part of an electronic communication.

In the case in which the buyer initiates an electronic communication with a phone call by calling a number associated with the data processing system, the data processing system may prompt the buyer for his Agent ID and PIN number (or the buyer may enter this information without prompting). The data processing system may then prompt the buyer to enter an MLS listing number for the property he desires to see. If the buyer does not know the number, then the buyer can optionally enter other identifying information, such as the street name and address number. After the property has been identified, the buyer may enter the requested showing time. The available or unavailable showing times may be stored in a database (for example, database 104) in a calendar associated with the given property. The database may retrieve this information and compare it to the requested showing time. If the data processing system identifies that the requested time is unavailable, the data processing system may prompt the user to enter a different time.

In the case in which the buyer initiates an electronic communication with a text by texting a number associated with the data processing system, the process may be similar to the automated phone call example. In essence, the buyer may text information including Agent ID, PIN number, property identifying data (either MLS number or address), and the desired showing time for the property. Such information may be entered in one or in multiple texts with or without intermediate prompting. The available or unavailable showing times may be stored in a database (for example, database 104) in a calendar associated with the given property. The database may retrieve this information and compare it to the requested showing time. If the data processing system identifies that the requested time is unavailable, the data processing system may prompt the user to enter a different time.

In the case in which the buyer initiates an electronic communication with an email or other communication through the Internet, the process may go as follows. In certain instances, an MLS system may provide a link or icon to schedule a showing on a given page for a property. When this icon or link is selected, the buyer may be directed to a seller's calendar view associated with the property. The calendar information may be stored in a database (for example, database 104) in association with the given property. The seller's calendar view may show the available times for showing the property. The seller's calendar view may also show times that are unavailable or blacked out. Such times may be specified by the seller. After selecting a showing time, the showing time for the property may be added to a virtual showing clipboard or to the buyer's calendar. The buyer may add multiple showings for multiple properties to this clipboard or buyer's calendar before finally checking out, which triggers the data processing system to begin making contact with sellers responsible for confirmation of each showing as further described below.

At step 210, it is determined whether seller confirmation is required to show the property. This preference information may be stored in the database in association with the given property. The data processing system may check the database to determine whether confirmation is required. If confirmation is not required, then the system may proceed to step 215. If confirmation is required, then the system may proceed to step 230.

At step 215, a showing is scheduled for the property at the requested time. The data processing system may schedule the showing and may also update the showing calendar information stored in the database. At step 220, showing instructions for the property are retrieved if it is determined whether such showing instructions are available. If there are no showing instructions, then none are retrieved. The showing instructions may be stored in the database. Showing instructions may include the following information: lockbox codes, lockbox locations, information about pets that are located on the premises, requests to remove footwear prior to entry, or the like.

At step 225, instructions and a confirmation of the showing are electronically communicated to the buyer (for example, during an automated phone call, via text, via email, and/or through presentation at a web portal). The confirmation and the instructions may be sent in the same electronic communication (for example, the original electronic communication originated from the buyer to the data processing system). The mode(s) of confirmation communications for the buyer may be stored in association with the buyer's Agent ID and may be stored in the database. The data processing system may prompt the buyer to determine if he wants to schedule more showings during the single electronic communication. If the buyer wants to schedule more showings, then the process may proceed again at step 205. If the buyer does not want to schedule more showings, then the flowchart may terminate. After appointment(s) have been scheduled, the data processing system may send a reminder via automated phone call, text, and/or email that a showing is to occur in a specified period of time (for example, in 20 minutes). The amount of time that a reminder is sent before the appointment may be specified by the buyer, either through his preferences or through the electronic communication.

At step 230, the seller's contact preferences are determined. The seller's contact preferences may be stored in the database. The seller's contact preference may be associated with the seller (for example, the seller's Agent ID) in the database. The seller's contact preference may vary from property-to-property or may be globally applicable for any listed property. The seller's contact preference may indicate the identit(ies) of the individuals to be contacted (for example, the listing agent or the property owner). For each individual, the seller's contact preferences may include a preference to be called via an automated call, texted, and/or emailed.

Preferences may include several different contact methods for each party responsible for confirmation, depending on time, dates and situational preferences. A confirming party may elect to receive contact via one method on certain days and times and another method on other days and times. A confirming party may also elect to have one primary contact method and additional contact methods used in the event that the primary method results in non-contact.

At step 235, a confirmation request to show the property at the requested time is sent by the data processing system to the seller according to the seller's contact preference. The confirmation request is sent via a new electronic communication which is initiated by the data processing system. If multiple individuals are contacted, they may be contacted simultaneously.

At step 240, the seller confirms, declines, or requests to reschedule to show the property at the requested time. If the confirmation request is sent by an automated phone call, a voice may prompt the seller stating that the buyer would like to show an identified property at the requested time. The seller may be prompted to respond to this and other inquiries either through the number pad or by speaking. The seller may be prompted to confirm or decline the confirmation request, thereby providing a confirmation result. If the seller confirms or agrees to the requested showing time, then the flowchart may proceed to step 215. If the seller declines, then the automated phone call may prompt the seller to see if there is an alternate time that works. If there is an alternate time, then the automated phone call may prompt the seller to enter the new time, thereby providing a confirmation result. Using the new time information, the flowchart may proceed to step 250. If there is no alternate time, then the flowchart may proceed to step 245.

If the confirmation request is sent by a text message, the process may be similar to that of the confirmation request being sent by an automated phone call. Instead of responding by voice or by entering numbers on a phone's keypad, the seller may respond by texting responsive information in response to the confirmation request promptings.

If the confirmation request is sent by an email, an email may be sent to the seller stating that the buyer would like to show an identified property at the requested time. The email may provide a number of optional links (or icons with an embedded link) to prompt the seller. For example, the email may have a link for the seller to choose for the seller to confirm the confirmation request, a link for the seller to choose if the seller declines the confirmation request, and/or a link for the seller to choose if the seller wants to reschedule the proposed showing time. If the seller confirms or agrees to the requested showing time by clicking on the appropriate link, then the flowchart may proceed to step 215. If the seller declines the confirmation request by clicking on the appropriate link, then the flowchart may proceed to step 245. If the seller requests to reschedule the showing time by clicking on the appropriate link, then the flowchart may proceed to step 250. In the instance that the seller wishes to reschedule the requested showing time, the seller may be prompted or may enter a new proposed showing time which is communicated to the data processing system. The reschedule link, for example, may take the seller to a web form through which the seller can specify a new suggested time for showing the property.

At step 245, if the seller declines to show the property at the requested time, an electronic communication is sent to the buyer providing the confirmation result denying the request. The electronic communication may be sent by the medium in which the confirmation request was generated, or it may be sent according to the buyer's communication preference. By declining a request, the data processing system may update the calendar for a given property and indicate the requested time as a blackout time or otherwise unavailable.

At step 250, if the seller requests to reschedule the showing, a new electronic communication providing the confirmation result is sent by the data processing system to the buyer. Such a choice may responsively generate an electronic communication to the buyer including the confirmation result. The electronic communication may be sent by the medium in which the confirmation request was generated, or it may be sent according to the buyer's communication preference. In the confirmation result, the electronic communication may inquire of the buyer whether the new time is acceptable. If the new time is acceptable, then the buyer may indicate so during this electronic communication. This may prompt the data processing system to initiate yet another electronic communication to the seller requesting confirmation of the new time (for example, the flowchart may loop back to step 240).

If the new time is not acceptable, then the buyer may indicate so in the electronic communication initiated from the data processing system to the buyer. In this instance, the data processing system may inquire of the buyer as to a preferable alternate time. If an alternate time is specified by the buyer, then the flowchart may loop back to step 205, step 230, or step 235, depending on design preference. These iterations may continue until an acceptable time is agreed upon. If the buyer provides no alternate time, then the process may end for the buyer and the seller may be notified by the data processing system that no time was agreed upon.

At various points during the flow of the method, the buyer may be asked if he wishes to schedule more showings for the same or for different properties. This may occur during a single electronic communication. Thus, a single electronic communication may include multiple showing requests.

Showing instructions and contact preferences may be set in the following manner. When the seller enters a new listing into the MLS, the new listing may automatically be imported from the MLS to the data processing system. Through the data processing system, the seller may set confirmation preferences, showing instructions, blackout times, or the like.

The seller may choose whether or not, for a given property, the inventive techniques disclosed herein will be applied. For example, a user may have to opt-in to leverage the benefits of the inventive techniques. If a listing is opted in, and no showing instructions are entered after the days, the data processing system may send an alert email to the seller, with a link to set showing instructions and confirmation preferences. If a showing is requested on a property that has no showing instructions specified, the system may respond to the buyer that the listing agent hasn't entered showing instructions, and inform the buyer to contact the seller directly for more info. The data processing system may also provide the showing agent with the contact information for the listing agent.

A basic implementation of the system may include an MLS-integrated showing calendar and ability to schedule showings through email only. A user may be provided with an option to upgrade to a more advanced implementation with enhanced functionality on a per-listing basis. Such an advanced implementation may include a showing calendar and the ability to schedule showings by clicking on a calendar icon in the MLS plus the ability to schedule showings by telephone or text messaging.

Some of the techniques discussed above may be implemented in conjunction with an MLS. It may also be possible to implement the techniques independent from an MLS. For example, an individual agent, team, or office may set up their own dial-in or texting number.

In addition to phone, text, email, and web-portal communications, the inventive techniques may also be implemented with push notifications (for example, push notifications through a mobile device application). Such push notifications may include the full content of an electronic communication or may notify the user to check another communication medium, such as email or text. As one example, a confirmation request may be sent to a seller and appear as a push notification. This may alert the seller to respond to the confirmation request. As another example, a push notification may be sent to the buyer including the showing instructions and/or confirmation. As another example, a push notification may be sent to the buyer indicating a request to reschedule or denying the showing request.

Certain operations described in this specification may be implemented in digital electronic circuitry, or in computer software, firmware, or hardware, including the structures disclosed in this specification (for example, data processing system 100) and their structural equivalents, or in combinations of one or more of them. Certain operations may be implemented as one or more computer program products, including one or more modules of computer program instructions encoded on one or more computer-readable mediums (for example, memor(ies) 102) for execution by, or to control the operation of, a data processing apparatus. A computer-readable medium may be a machine-readable storage device, a machine-readable storage substrate, a memory device, a composition of matter affecting a machine-readable propagated signal, or a combination of one or more of them. The term “data processing system” encompasses all apparatus, devices, and machines for processing data, including by way of example a programmable processor, a computer, or multiple processors or computers. The data processing system may include, in addition to hardware, code that creates an execution environment for the computer program in question, for example, code that constitutes processor firmware, a protocol stack, a database management system, an operating system, or a combination of one or more of them. A propagated signal may be an artificially generated signal, for example a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a data processing system are processor(s) for performing instructions and one or more memory devices for storing instructions and data. Generally, a data processing system will also include, or be operatively coupled to receive data from or transfer data to, or both, one or more mass storage devices for storing data, for example, magnetic, magneto-optical disks, or optical disks. However, a data processing system need not have such devices. Moreover, a data processing system may be embedded in another device, for example, a mobile telephone, a personal digital assistant (“PDA”), a mobile audio player, a Global Positioning System (“GPS”) receiver, to name just a few. Computer-readable media suitable for storing computer program instructions and data include all forms of non-volatile memory, media and memory devices, including by way of example semiconductor memory devices, for example, EPROM, EEPROM, and flash memory devices, magnetic disks, for example, internal hard disks or removable disks, magneto-optical disks, and CD-ROM and DVD-ROM disks. The processor(s) and the memory device(s) may be supplemented by, or incorporated in, special purpose logic circuitry.

To provide for interaction with a user, certain operations may be implemented on a computer having a display device, for example, a cathode ray tube (“CRT”) monitor, a liquid crystal display (“LCD”) monitor, or a light-emitting diode (“LED”) monitor for displaying information to the user and a keyboard and a pointing device, for example, a mouse or a trackball, by which the user may provide input to the data processing system. Other kinds of devices may be used to provide for interaction with a user as well, for example, feedback provided to the user may be any form of sensory feedback, for example, visual feedback, auditory feedback, or tactile feedback, and input from the user may be received in any form, including acoustic, speech, or tactile input.

Certain operations may be implemented in a data processing system that includes a back-end component, for example, a data server, or that includes a middleware component, for example, an application server, or that includes a front-end component, for example, a client computer having a graphical user interface or a Web browser through which a user may interact according to techniques of this application, or any combination of one or more such back-end, middleware, or front-end components. The components of the system may be interconnected by any form or medium of digital data communication, for example, a communication network. Examples of communication networks include a local area network (“LAN”) and a wide area network (“WAN”), for example, the Internet.

The data processing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of this application or of what may be claimed, but rather as descriptions of features specific to particular techniques of this application. Certain features that are described in this specification in the context of separate techniques may also be implemented in combination in a single embodiment. Conversely, various features that are described in the context of a single embodiment may also be implemented in multiple techniques separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the techniques described above should not be understood as requiring such separation in all techniques, and it should be understood that the described program components and systems may generally be integrated together in a single software product or packaged into multiple software products.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A method for scheduling a property showing with a data processing system, wherein the method comprises:
receiving, by the data processing system, an electronic communication from a buyer, wherein the electronic communication from the buyer includes:
identification data to uniquely identify a property; and
requested showing time data including a requested showing time for the property;
determining, by the data processing system, whether confirmation by a seller is required prior to showing the property;
if the confirmation by the seller is not required:
scheduling, by the data processing system, a showing at the property during the requested showing time;
determining, by the data processing system, whether showing instructions for the property are available;
if the showing instructions are available, retrieving, by the data processing system, the showing instructions; and
if the showing instructions have been retrieved, electronically communicating, by the data processing system the showing instructions to the buyer; and
if confirmation by the seller is required, sending, by the data processing system, a confirmation request via an electronic communication to the seller requesting a showing of the property at the requested showing time.

2. The method of claim 1, wherein if confirmation by the seller is required, further comprising:
receiving, by the data processing system, an electronic communication from the seller including a confirmation result in response to the confirmation request, wherein the confirmation result includes a confirmation result to show the property at the requested showing time, a denial to show the property at the requested showing time, or a request to reschedule the property showing from the requested showing time to a different showing time; and
sending, by the data processing system, an electronic communication to the buyer including the confirmation result.

3. The method of claim 2, wherein if the confirmation result comprises a confirmation result to show the property at the requested showing time, further comprising:
scheduling, by the data processing system, the property showing at the requested showing time;
determining whether the showing instructions are available;
if the showing instructions are available, retrieving, by the data processing system, the showing instructions; and
if the showing instructions have been retrieved, sending, by the data processing system, an electronic communication to the buyer including the showing instructions.

4. The method of claim 3, wherein one electronic communication includes both:
the electronic communication to the buyer including the confirmation result; and
the electronic communication to the buyer including the showing instructions.

5. The method of claim 1, wherein if confirmation by the seller is required, further comprising:
determining, by the data processing system, a contact preference for the seller; and
wherein said sending an electronic communication to the seller comprises sending the electronic communication to the seller according to the contact preference.

6. A method for scheduling a plurality of property showings with a data processing system, wherein the method comprises:
receiving, by the data processing system, at least one electronic communication from a buyer, wherein the at least one electronic communication from the buyer includes:
identification data to uniquely identify each of a plurality of properties; and
requested showing time data including a requested showing time for each of the plurality of properties;
determining, by the data processing system, for each of the plurality of properties whether confirmation by a corresponding seller is required;
for each of the plurality of properties, if the confirmation by a given seller is not required:
scheduling, by the data processing system, a showing at a given one of the plurality of properties during a corresponding requested showing time;
determining, by the data processing system, whether showing instructions for the given one of the plurality of properties are available;
if the showing instructions are available, retrieving, by the data processing system, the showing instructions; and
if the showing instructions have been retrieved, electronically communicating, by the data processing system the showing instructions to the buyer; and
for each of the plurality of properties, if confirmation by a given seller is required, sending, by the data processing system, a confirmation request via an electronic communication to the given seller requesting a showing of a given one of the plurality of properties at the requested showing time.

7. The method of claim 6, wherein for each of the plurality of properties, if confirmation by the given seller is required, further comprising:
receiving, by the data processing system, an electronic communication from the given seller including a confirmation result in response to a corresponding confirmation request, wherein the confirmation result includes a confirmation result to show a given one of the plurality of properties at a corresponding requested showing time, a denial to show the given one of the plurality of properties at the requested showing time, or a request to reschedule the property showing from the corresponding requested showing time to a different showing time; and
sending, by the data processing system, an electronic communication to the buyer including the confirmation result.

8. The method of claim 7, wherein if the confirmation result comprises a confirmation result to show the given one of the plurality of properties at the corresponding requested showing time, further comprising:
scheduling, by the data processing system, a property showing for the given one of the plurality of properties at the corresponding requested showing time;
determining whether showing instructions are available for the given one of the plurality of properties;
if the showing instructions for the given one of the plurality of properties are available, retrieving, by the data processing system, the showing instructions for the given one of the plurality of properties; and
if the showing instructions for the given one of the plurality of properties have been retrieved, sending, by the data processing system, an electronic communication to the buyer including the showing instructions for the given one of the plurality of properties.

9. The method of claim 8, wherein one electronic communication includes both:
each electronic communication to the buyer including the confirmation result; and
each electronic communication to the buyer including the showing instructions.

10. The method of claim 6, wherein, for each of the plurality of properties, if confirmation by the given seller is required, further comprising:
determining, by the data processing system, a contact preference for the given seller; and
wherein said sending an electronic communication to the given seller comprises sending the electronic communication to the given seller according to the contact preference.

11. At least one computer-readable medium including instructions executable to cause a data processing system to perform operations comprising:
receiving an electronic communication from a buyer, wherein the electronic communication from the buyer includes:
identification data to uniquely identify a property; and
requested showing time data including a requested showing time for the property;
determining whether confirmation by a seller is required prior to showing the property;
if the confirmation by the seller is not required:
scheduling a showing at the property during the requested showing time;
determining whether showing instructions for the property are available;
if the showing instructions are available, retrieving the showing instructions; and
if the showing instructions have been retrieved, electronically communicating, by the data processing system the showing instructions to the buyer; and
if confirmation by the seller is required, sending a confirmation request via an electronic communication to the seller requesting a showing of the property at the requested showing time.

12. The at least one computer-readable medium of claim 11, wherein if confirmation by the seller is required, the instructions are executable by the data processing system to perform further operations comprising:
Receiving an electronic communication from the seller including a confirmation result in response to the confirmation request, wherein the confirmation result includes a confirmation result to show the property at the requested showing time, a denial to show the property at the requested showing time, or a request to reschedule the property showing from the requested showing time to a different showing time; and
sending an electronic communication to the buyer including the confirmation result.

13. The at least one computer-readable medium of claim 11, wherein if the confirmation result comprises a confirmation result to show the property at the requested showing time, the instructions are executable by the data processing system to perform further operations comprising:
scheduling the property showing at the requested showing time;
determining whether showing instructions for the property are available;
if the showing instructions are available, retrieving the showing instructions; and
if the showing instructions have been retrieved, sending an electronic communication to the buyer including the showing instructions.

14. The at least one computer-readable medium of claim 13, wherein one electronic communication includes both:
the electronic communication to the buyer including the confirmation result; and
the electronic communication to the buyer including the showing instructions.

15. The at least one computer-readable medium of claim 11, wherein if confirmation by the seller is required, the instructions are executable by the data processing system to perform further operations comprising:
determining a contact preference for the seller; and
wherein said sending an electronic communication to the seller comprises sending the electronic communication to the seller according to the contact preference.

16. At least one computer-readable medium including instructions executable to cause a data processing system to perform operations comprising:
receiving at least one electronic communication from a buyer, wherein the at least one electronic communication from the buyer includes:
identification data to uniquely identify each of a plurality of properties; and
requested showing time data including a requested showing time for each of the plurality of properties;
determining for each of the plurality of properties whether confirmation by a corresponding seller is required;
for each of the plurality of properties, if the confirmation by a given seller is not required:
scheduling a showing at a given one of the plurality of properties during a corresponding requested showing time;
determining whether showing instructions for the given one of the plurality of properties are available;
if the showing instructions are available, retrieving the showing instructions; and
if the showing instructions have been retrieved, electronically communicating, by the data processing system the showing instructions to the buyer; and
for each of the plurality of properties, if confirmation by a given seller is required, sending a confirmation request via an electronic communication to the given seller requesting a showing of a given one of the plurality of properties at the requested showing time.

17. The at least one computer-readable medium of claim 16, wherein the instructions are executable by the data processing system to perform further operations comprising:
receiving an electronic communication from the given seller including a confirmation result in response to a corresponding confirmation request, wherein the confirmation result includes a confirmation result to show a given one of the plurality of properties at a corresponding requested showing time, a denial to show the given one of the plurality of properties at the requested showing time, or a request to reschedule the property showing from the corresponding requested showing time to a different showing time; and
sending an electronic communication to the buyer including the confirmation result.

18. The at least one computer-readable medium of claim 17, wherein if the confirmation result comprises a confirmation result to show the given one of the plurality of properties at the corresponding requested showing time, the instructions are executable by the data processing system to perform further operations comprising:
scheduling a property showing for the given one of the plurality of properties at the corresponding requested showing time;
determining whether showing instructions are available for the given one of the plurality of properties;
if the showing instructions are available, retrieving the showing instructions; and
if the showing instructions for the given one of the plurality of properties have been retrieved, sending an electronic communication to the buyer including the showing instructions.

19. The at least one computer-readable medium of claim 18, wherein one electronic communication includes both:
each electronic communication to the buyer including the confirmation result; and
each electronic communication to the buyer including the showing instructions.

20. The at least one computer-readable medium of claim 16, wherein, for each of the plurality of properties, if confirmation by the given seller is required, the instructions are executable by the data processing system to perform further operations comprising:
determining a contact preference for the given seller; and
wherein said sending an electronic communication to the given seller comprises sending the electronic communication to the given seller according to the contact preference.
